(19) United States
(12) Patent Application Publication
(10) Pub. No.: US 2011/0002038 A1
(43) Pub. Date: Jan. 6, 2011

(54) THREE-DIMENSIONAL IMAGE FORMATION DEVICE

(75) Inventor: TSUNG-WU WANG, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: TENDRIL-TECH CO., LTD., TAIPEI CITY (TW)

(21) Appl. No.: 12/731,386

(22) Filed: Mar. 25, 2010

(30) Foreign Application Priority Data
Jul. 3, 2009 (TW) 098212053

(51) Int. Cl. G02B 27/22

(52) U.S. Cl. 359/479

(57) ABSTRACT

A three-dimensional 3D image formation device includes a mounting box, an image source device, a plurality of transparent reflecting lenses and a top panel. Reflection principles are used for reflecting a plurality of image sources of the image source device onto the transparent reflecting lenses tilted at an angle of 45 degrees, such that a viewer can view a 3D image floating in the air from any angle, and the 3D image formation device gives a lively 3D perception of the image to enhance the value of the product.

### BACKGROUND OF THE INVENTION

1. Field of the Invention

The present invention relates to a three-dimensional (3D) image formation device comprised of a mounting box, an image source device, a plurality of transparent reflecting lenses and a top panel and uses reflection principles to reflect a plurality of image sources of the image source device onto the transparent reflecting lenses tilted at 45 degrees, such that a viewer can view a 3D image floating in the air from any angle, and the invention further gives a lively 3D perception of the image to enhance the value of the product.

2. Description of the Related Art

In binocular vision, an object is observed from two viewing angles (or left and right eyes) simultaneously. Positions of left and right eyes are different, so that there is a slight difference between the images observed by the left and right eyes, and such difference becomes a main cause of producing 3D images.

The so-called “persistence of vision” refers to the phenomenon where our eyes retain an image temporarily after the image was actually seen and removed. For example, the persistence of vision is used for the production of cartoon movies. Pictures of a continuous motion are drawn on a stack of paper one by one according to the motion of a character. Before an image disappears completely, another image shows up in front of our eyes, due to the persistence of vision. Now, the eyes will produce an illusion with the effect like “a piece of still paper is moving”. If more pieces of pictures of the continuous motion are flipped in a specific time, then the motion of the character will become smoother and more realistic.

The frames of televisions and movies are also made by the same principles, except that approximately 15˜20 frames are played per second in general cartoon movies, and 24˜30 frames are played per second in televisions and movies.

Although the principles of forming 3D images have been developed for a long time, the 3D effect is still not good, and the bottleneck of forming a high-quality 3D image cannot be broken through. Furthermore, the prior art makes use of different spectral wavelengths and a time difference of one-thirtieth frame per second to cover the left and right eyes in order to produce an illusion of the 3D image. Users need to wear a pair of 3D glasses to see the 3D effect. Obviously, the prior art is inconvenient. In view of the shortcomings of the conventional products, the inventor of the present invention based on years of experience in the related industry to conduct extensive researches and experiments, and finally developed a 3D image formation device in accordance with the present invention.

### SUMMARY OF THE INVENTION

It is a primary objective of the present invention to overcome the shortcomings of the prior art by providing a 3D image formation device comprising a mounting box, an image source device, a plurality of transparent reflecting lenses and a top panel, wherein reflection principles are used for reflecting a plurality of image sources of the image source device onto the transparent reflecting lenses tilted at an angle of 45 degrees, such that viewers can see a 3D image floating in the air from any angle without the need of wearing a pair of 3D glasses, and the invention further gives a lively 3D perception of the image to enhance the value of the product.

To achieve the foregoing objective, the present invention adopts the following technical measures.

With reference to FIGS. 1 to 3 for a 3D image formation device of the present invention, the 3D image formation device comprises a mounting box 10, an image source device 11, a transparent reflecting lens 13 and a top panel 14.

The mounting box 10 is substantially a rectangular box provided for supporting and mounting the 3D image formation device, and a power connector 12 is coupled to the bottom of the mounting box 10 for supplying electric power.

The image source device 11 is installed at an internal edge of the top of the mounting box 10, wherein the image source device 11 is a device such as a television screen, a liquid crystal display screen, or a projector provided for playing image sources.

Each of four transparent reflecting lenses 13 has a see-through reflecting film 131 attached onto an external surface of the transparent reflecting lens 13 and tilted together with the image source device 11 at an angle of 45 degrees and the four transparent reflecting lenses 13 are combined into an inverted pyramid shape and fixed at the top of the image source device 11.

The top panel 14 is substantially an opaque square panel fixed at the top of the four transparent reflecting lenses 13 to constitute an integral structure for displaying a 3D image 2.

In FIG. 4, the image source device 11 mounted onto the internal edge of the top of the mounting box 10 includes four image source patterns 21 disposed at positions corresponding to the four transparent reflecting lenses 13 tilted at 45 degrees, and the four image source patterns 21 are projected onto the four transparent reflecting lenses 13 that are combined into an inverted pyramid shape, such that the four image source patterns 21 can be combined at the center of the four transparent reflecting lenses 13 to show a 3D image 2.

With reference to FIG. 5 the principle of forming a 3D image in accordance with the present invention, the transparent reflecting lens 13 and the image source device 11 installed at the internal edge of the top of the mounting box 10 are installed and tilted at an angle of 45 degrees, and a distance D1 between the image source position 15 and the image reflecting position 16 is equal to the distance D2 between the image reflecting position 16 and the image forming position 17, so that the images can be combined into a 3D image at the image forming position 17.

To make it easier for our examiner to understand the objects, effects and advantages of the present invention, we use preferred embodiments with related drawings for the detailed description of the present invention as follows.

### BRIEF DESCRIPTION OF THE DRAWINGS

FIG. 1 is a perspective view of the present invention;

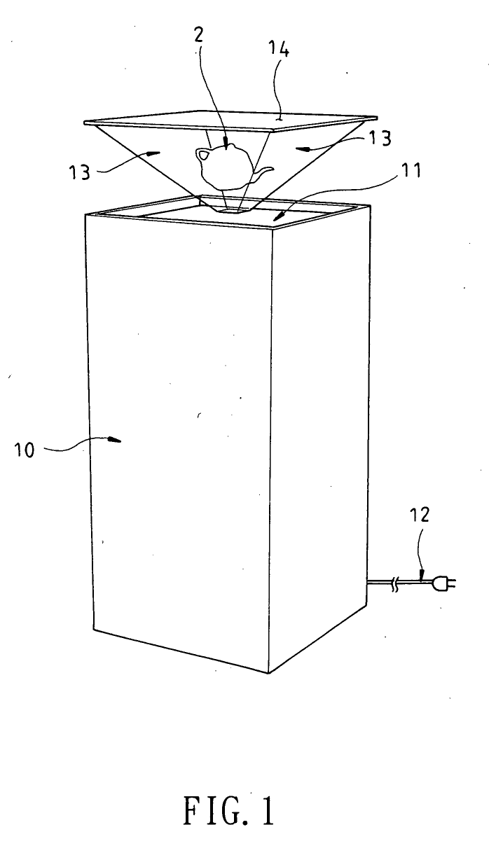

FIG. 2 is an exploded view of the present invention;

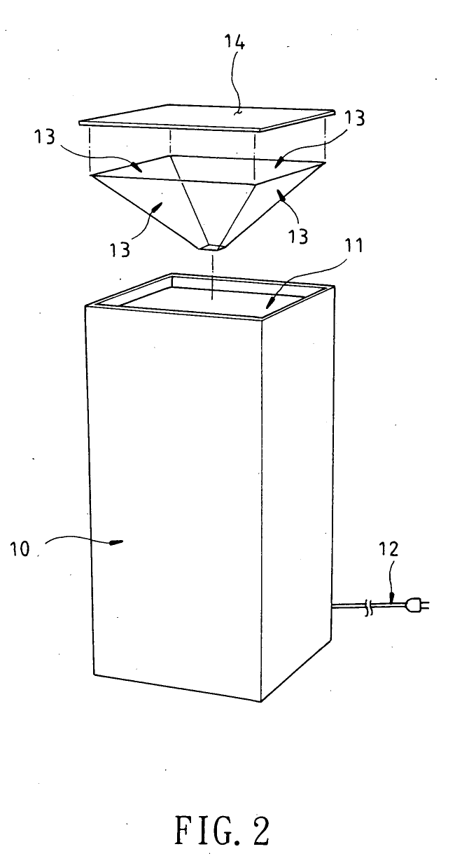

FIG. 3 is a schematic view of a lateral side of a transparent reflecting lens in accordance with the present invention;

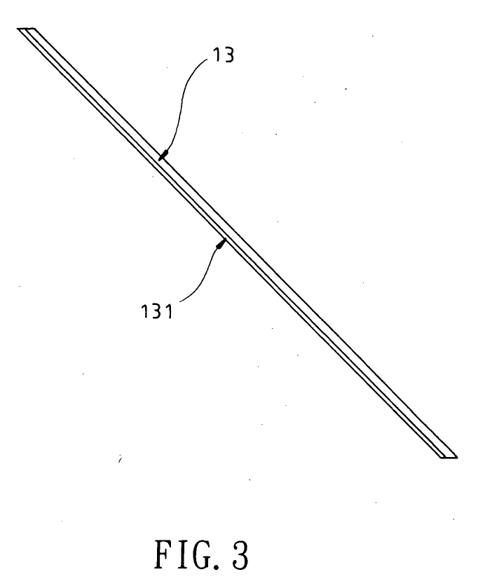

FIG. 4 is a schematic view of forming a 3D image in accordance with the present invention;

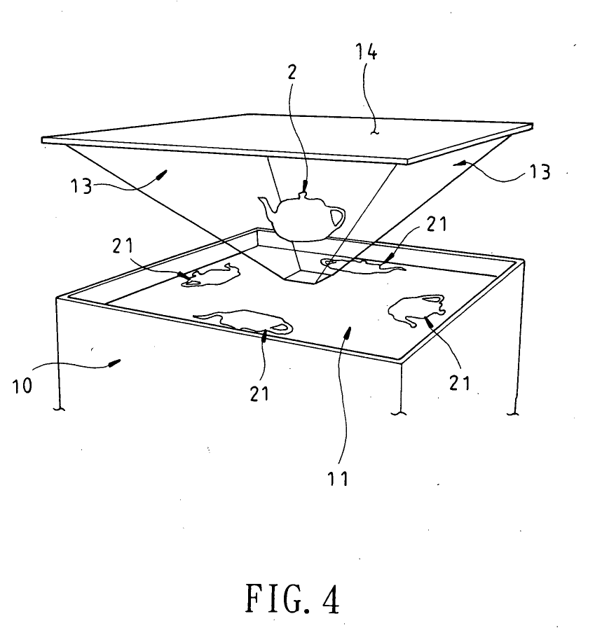

FIG. 5 is a schematic view showing the principle of forming a 3D image in accordance with the present invention;

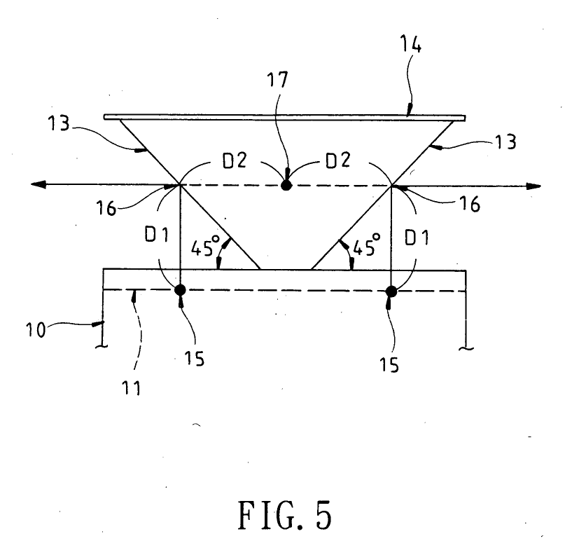

FIG. 6 is a schematic view of a preferred embodiment of the present invention;

FIG. 7 is a perspective view of another preferred embodiment of the present invention;

FIG. 8 is an exploded view of another preferred embodiment of the present invention;

FIG. 9 is a schematic view of a lateral side of a transparent reflecting lens in accordance with another preferred embodiment of the present invention; and

FIG. 10 is a schematic view showing the principle of forming a 3D image in accordance with another preferred embodiment of the present invention.

### DETAILED DESCRIPTION OF THE PREFERRED EMBODIMENTS

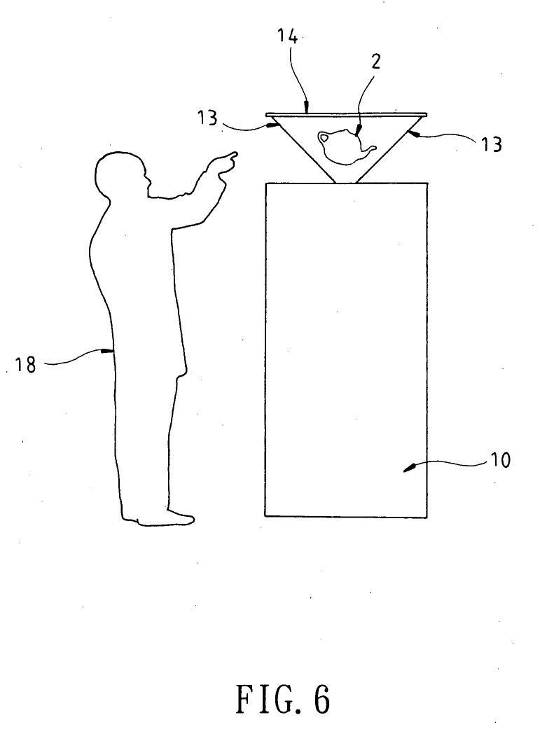

With reference to FIG. 6 together with the aforementioned components of the 3D image formation device of the present invention before the 3D image formation device is assembled, the present invention uses reflection principles to reflect four image sources onto the transparent reflecting lenses 13 that are combined into an inverted pyramid shape, so as to allow a viewer 18 to see a 3D image floating in the air 2 from any angle. Due to a specific reflecting angle of the present invention, the viewer 18 can see one image at a time from the same angle. For dynamic and rotating or moving images, a more lively 3D perception effect of the images can be achieved.

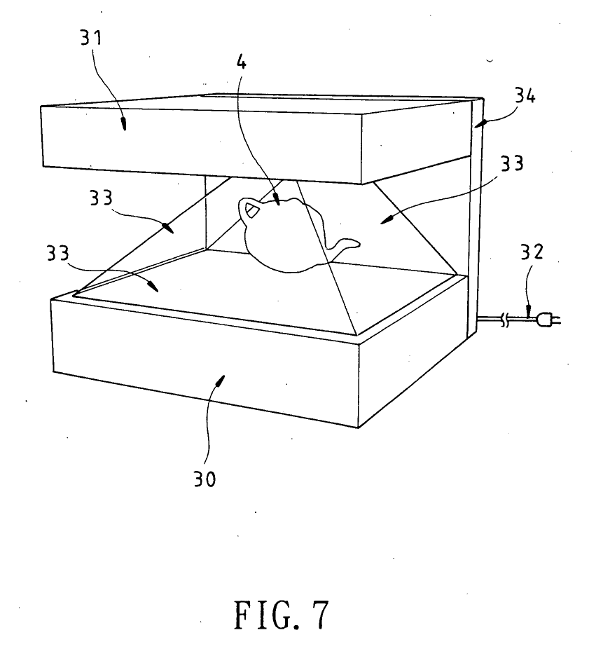

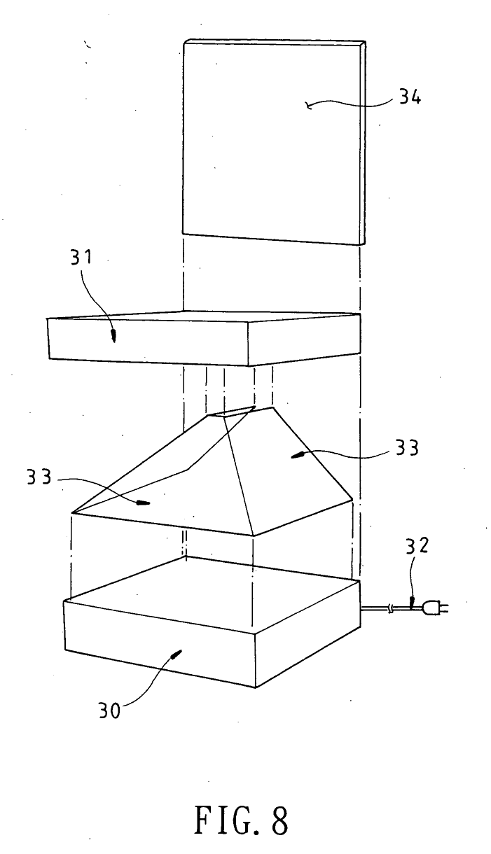

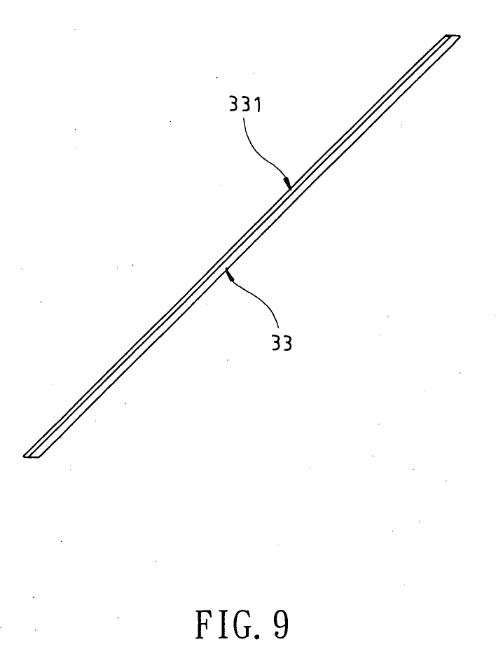

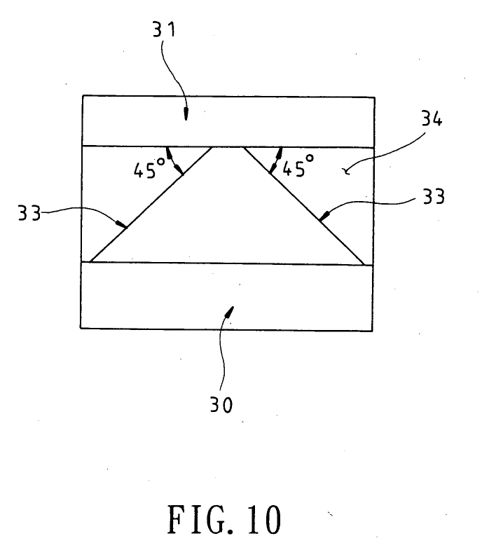

With reference to FIGS. 7 to 10 for a 3D image formation device in accordance with another preferred embodiment of the present invention, the 3D image formation device comprises a mounting box 30, an image source device 31, a transparent reflecting lens 33 and a back panel 34.

The mounting box 30 is substantially a rectangular box provided for supporting and mounting the 3D image formation device of the present invention, and a power connector 32 is coupled to the bottom of the mounting box 30 for supplying electric power.

The image source device 31 is installed at an internal edge of the top of the mounting box 30.

Each of three transparent reflecting lenses 33 has a see-through reflecting film 331 attached onto an external surface of the transparent reflecting lens 33 and tilted together with the image source device 31 at an angle of 45 degrees and the three transparent reflecting lenses 33 are fixed at the top of the mounting box 30.

The back panel 34 is substantially an opaque rectangular panel fixed at the back of the mounting box 30, the three transparent reflecting lenses 33 and the image source device 31 to constitute an integral structure for displaying a 3D image 4.

While the invention has been described by means of specific embodiments, numerous modifications and variations could be made thereto by those skilled in the art without departing from the scope and spirit of the invention set forth in the claims.

In summation of the above description, the present invention herein enhances the performance than the conventional structure and further complies with the patent application requirements and is duly filed for patent application.

What is claimed is:

1. A three-dimensional (3D) image formation device, comprising a mounting box, an image source device, a transparent reflecting lens and a top panel, characterized in that:
the mounting box is substantially a rectangular box provided for supporting and mounting the 3D image formation device, and a power connector is coupled to the bottom of the mounting box for supplying electric power;
the image source device is installed at an internal edge of the top of the mounting box;
each of four transparent reflecting lenses has a see-through reflecting film attached onto an external surface of each transparent reflecting lens, and the transparent reflecting lenses and the image source device are tilted at an angle of 45 degrees, and the four transparent reflecting lenses are combined into an inverted pyramid shape and fixed onto the top of the image source device; and
the top panel is substantially an opaque square panel coupled to the top of the four transparent reflecting lenses to form an integral structure.

2. A three-dimensional (3D) image formation device, comprising a mounting box, an image source device, a transparent reflecting lens and a back panel, characterized in that:
the mounting box is substantially a rectangular box provided for supporting and mounting the 3D image formation device, and a power connector is coupled to the bottom of the mounting box for supplying electric power;
the image source device is installed at an internal edge of the top of the mounting box;
each of three transparent reflecting lens has a see-through reflecting film attached onto an external surface of each transparent reflecting lens, and the transparent reflecting lenses and the image source device are tilted at an angle of 45 degrees, and the three transparent reflecting lenses are fixed onto the top of the mounting box; and
the back panel is substantially an opaque rectangular panel coupled to the back of the three transparent reflecting lenses, the transparent reflecting lens and the image source device to form an integral structure.
